(19) United States
(12) Patent Application Publication
(10) Pub. No.: US 2003/0033256 A1
(43) Pub. Date: Feb. 13, 2003

(54) Method and system for electronically processing transactions

(76) Inventors: Thomas I. Rogan, Wethersfield, CT (US); Barbara Reid Macy, Enfield, CT (US)

Correspondence Address: CARLSON, GASKEY & OLDS, P.C., 400 WEST MAPLE ROAD, SUITE 350, BIRMINGHAM, MI, 48009, US

(21) Appl. No.: 09/924,372

(22) Filed: Aug. 8, 2001

(51) Int. Cl. G06F 17/60

(52) U.S. Cl. 705/64

(57) ABSTRACT

An electronically-based transaction handling system utilizes a single transaction identifier during all phases of the order-to-cash trading cycle. Information regarding the various phases of the transaction is linked to or associated with the transaction identifier and readily accessible by a plurality of remotely located users. The transaction information preferably is updated to provide up-to-date information to the various parties involved in the transaction. The single transaction identifier eliminates the need for handling various papers and matching multiple sources of information that was previously required during a typical transaction.

### BACKGROUND OF THE INVENTION

This invention generally relates to electronically processing transactions and more particularly to a method and system that utilizes a transaction identifier as a basis for maintaining all information regarding the various stages of the transaction.

Typical transactions begin with a purchase order or a long term purchase agreement that is negotiated between a supplier and a customer. There typically is paperwork associated with preparing the purchase order or long term purchase agreement. A next phase of the transaction typically involves the supplier gathering the ordered items and preparing them for shipping. There typically is paperwork involved with preparing shipping labels and shipping orders, for example. Additionally, an invoice is typically prepared for the customer, which can be reviewed upon receipt of the ordered items. Further, the receipt of the goods at the customer's facility is subject to double identification and handling on the part of the shipper and the customer. The customer then typically completes additional paperwork to arrange for payment to the supplier.

While electronic commerce has begun to simplify transactions by eliminating some of the paperwork that has traditionally been utilized, inefficiencies in existing systems should be overcome. One advance is shown in U.S. Pat. No. 6,015,167, which is commonly owned with this invention. In that patent, a single bar code is used to identify ordered goods and to provide a reference for the buyer and seller. There still are redundancies, even with the addition of known electronic facilitation of ordering, releasing, shipping, receiving and paying for items. For example, there typically still are invoices, purchase orders, shipment releases, shipping notices, packing slips prepared separately, having separate numbers or other identifiers that must be tracked or otherwise reconciled. Additionally, there are inefficiencies in tracking the stages of a transaction and facilitating the next steps along the way.

Prior to this invention no one has provided a fully integrated system where a supplier, shipper and customer all utilize a single transaction identifier during all phases of the order-to-cash cycle of a transaction. This invention provides a unique approach to enhancing the flow of trade by utilizing electronic transaction capabilities to minimize paperwork and redundancies in the transaction process.

### SUMMARY OF THE INVENTION

In general terms, this invention is a system for electronically handling transactions. A system designed according to this invention includes the use of a transaction identifier that identifies a transaction. A tracking module includes status information regarding the transaction and links that information to the identifier. The tracking module updates the status information during stages of the transaction. The tracking module provides access to the status information to a plurality of users such that a user of the system can automatically access the status information (i.e., using the internet or wireless technology) simply by using the transaction identifier.

In one example, the transaction identifier comprises a single bar code representing a number. The transaction identifier preferably includes information identifying a customer, a purchaser order number and a shipment release number. The status information regarding the transaction includes things such as a shipper identifier, an invoice number, customer receipt information and payment information.

A method of this invention includes several steps. A transaction identifier is established for use during all stages of the transaction. The transaction identifier is electronically stored such that the identifier and information associated with that identifier is remotely accessible by a plurality of users. Supplier information is linked with the transaction identifier. Purchaser information is linked with the transaction identifier. Status information indicating the status of the transaction during a corresponding phase of the transaction is updated during the various stages of the transaction. The status information is linked to the transaction identifier.

Accordingly, utilizing a single transaction identifier allows a plurality of users to obtain information regarding the status of a transaction. Additionally, a system designed according to this invention facilitates the plurality of users providing information to the system so that the system can automatically update the status information consistent with the completion of the various stages of the transaction.

The various features and advantages of this invention will become apparent to those skilled in the art from the following description of the currently preferred embodiment. The drawings that accompany the detailed description can be briefly described as follows.

### BRIEF DESCRIPTION OF THE DRAWINGS

FIG. 1 schematically illustrates a system designed according to this invention.

FIG. 2 schematically illustrates a transaction identifier designed according to this invention as incorporated into a label that is useful with this invention.

FIG. 3 includes a flow chart illustration of a process used in accordance with this invention.

FIG. 4 includes a flow chart that illustrates another aspect of a process used in accordance with this invention.

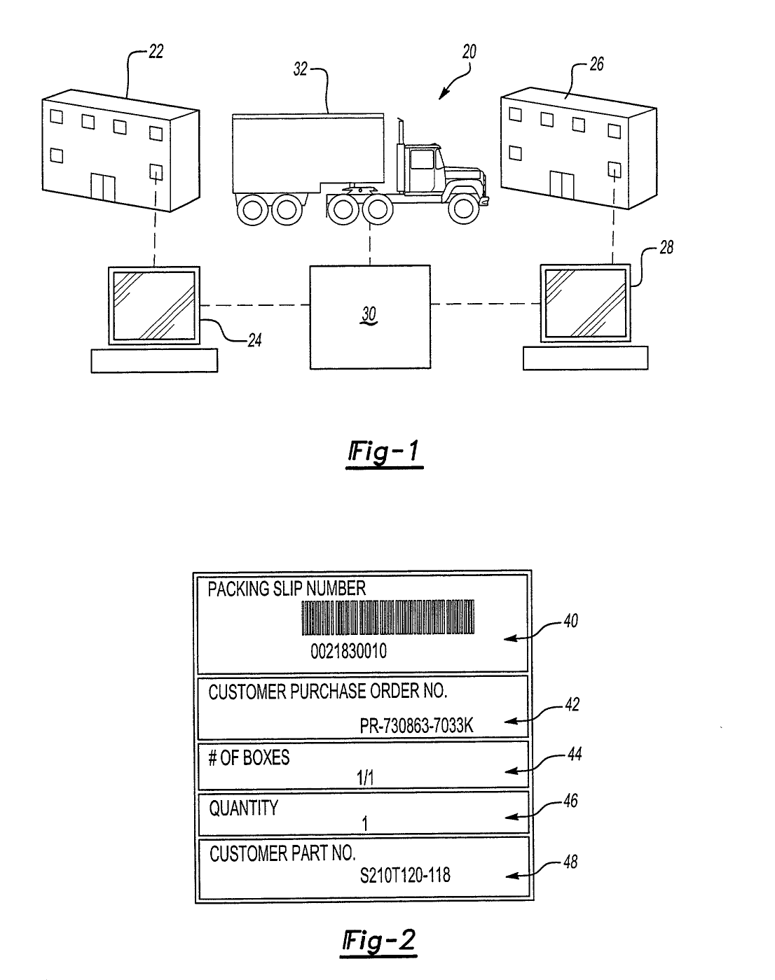

### DETAILED DESCRIPTION OF THE PREFERRED EMBODIMENT

An electronically-based system 20 for handling transactions preferably facilitates all phases of a transaction between a supplier and a customer. A single transaction identifier preferably is linked to or associated with all information regarding the transaction from the initial purchase order or long term purchase agreement to the completion of delivery of and payment for the ordered items. The system 20 provides a progressive, electronically based, two-way match to update the transaction information as information is received establishing the completion of various phases of the transaction.

A supplier location 22 includes a supplier module 24, which preferably is computer-based. The supplier module 24 may be a portion of a supplier's in-house legacy system or intranet system, for example. The term “module” as used in this description is intended for illustration purposes only. The term module should not be construed to be a single portion of computer software or hardware, for example. Instead, the term module should be construed in a broad sense to include any number of software programs or hardware devices that can be employed to accomplish the results provided by this invention.

A remotely located customer location 26 preferably includes a customer module 28. The customer module 28 may be the customer's in-house legacy system or intranet system, for example. A variety of computer-based systems may be appropriately configured to serve as the customer module 28.

The supplier module 24 and the customer module 28 preferably communicate with a tracking module 30, which may be remotely located from both the supplier module 24 and the customer module 28. Alternatively, the tracking module 30 may be incorporated as part of the supplier module 24 depending on the needs of a particular situation.

The various modules are schematically illustrated separately for discussion purposes only. There may be overlap or shared portions of each module within other modules, for example. Those skilled in the art who have the benefit of this description will be able to determine the best way to apportion the various functions of a system designed according to this invention to achieve the most efficient results for the needs of a particular situation. Similarly, those who have the benefit of this description will be able to appropriately program computers or other devices to perform the functions of a system designed according to this invention.

A carrier 32 preferably utilizes remote communication devices for communicating with the tracking module 30. The carrier devices may be, for example, hand held bar code readers that have the ability for wirelessly communicating with the tracking module 30.

The tracking module 30 preferably gathers information from the supplier module 24, the customer module 28 and the carrier 32 during the different phases of the transaction. Such information regarding the transaction preferably is updated as each phase of the transaction is completed. The tracking module 30 preferably provides access to a plurality of users (i.e., the supplier, customer and carrier) so that the status of the transaction can be monitored at any time. Additionally, the updated status information facilitates automatically carrying out portions of the transaction as will be described below.

This invention reduces the amount of paperwork and redundancies that have typically been required to complete transactions. By utilizing a single transaction identifier in linking all transaction information to that identifier, maintaining appropriate records during and after a transaction and obtaining ready access to those records is greatly simplified.

FIG. 2 shows an example label designed for use in the system 20 including a transaction identifier 40. A single bar code preferably is recognized by the system 20 as representing a plurality of pieces of information. In the illustrated example, the bar code 40 represents a customer purchase order number 42, quantity information 44 and 46 regarding the order and item identification such as a part number 48. Additional information could be incorporated into the bar code 40. Similarly, less information may be incorporated into the bar code 40. The single transaction identifier provides the system the ability to link all information regarding the transaction so that it can be readily accessed by a variety of individuals at remote locations by simply entering the transaction identifier into an appropriate computer or other device, for example.

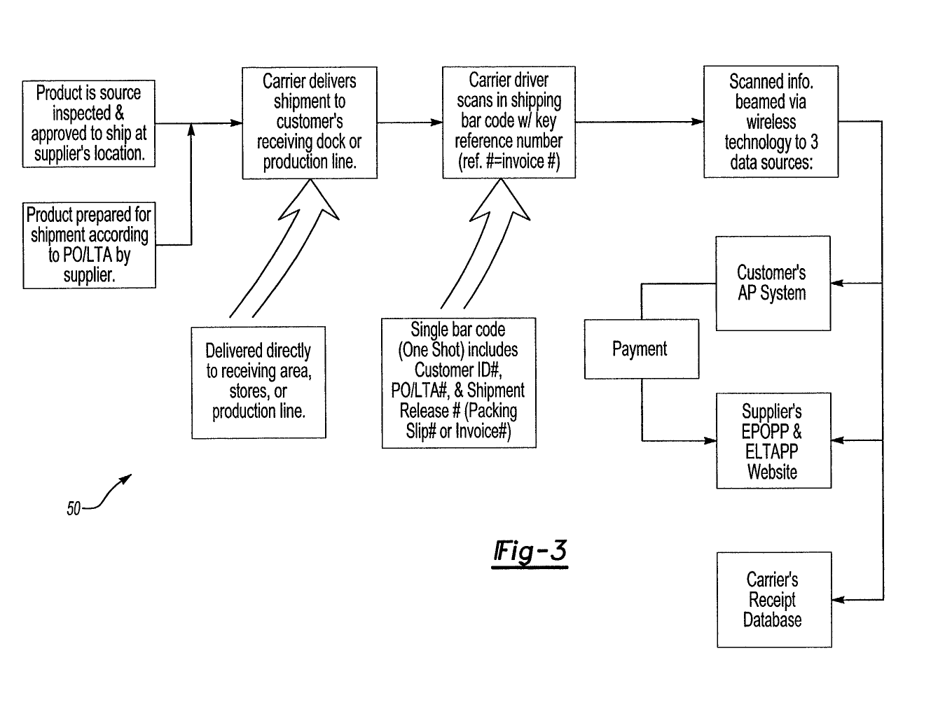

The process of a typical transaction carried out using this invention is illustrated in the flow chart 50 of FIG. 3. A purchase order or long term purchase agreement is negotiated between the supplier and customer in a conventional manner. Upon receiving the order, the supplier preferably provides information to the system 20 that results in the generation of the transaction identifier 40. In one example, the transaction identifier matches a purchase order number. In another example, the transaction identifier matches a long term purchase agreement number. Any arbitrary number or collection of symbols may be used as the transaction identifier. Utilizing a purchase order number or long term agreement number has the advantage of allowing a supplier to continue utilizing existing procedures for assigning purchase order or agreement numbers.

Once the order has been appropriately arranged, it is then provided to a carrier for shipment. The carrier enters the transaction identifier into the carrier's data base, which is also tracked by the tracking module 30. At this phase of the transaction, the tracking module 30 preferably contains or has access to information regarding the contents of the order, the carrier, the date of receipt by the carrier and any other relevant information entered by the supplier or the carrier. While in route, the carrier may update the transaction information by providing information to the tracking module 30 regarding location of the shipment, expected arrival date, etc. All such information preferably is linked to and accessible using the identifier 40.

Once the carrier arrives at a location specified by the customer, the carrier preferably enters the transaction identifier and an appropriate code or signal indicating that the shipment has been delivered. In one example, this is accomplished using a hand held device having a wand reader that reads in the bar code 40. By utilizing additional input devices in one example, the carrier is able to indicate other information such as time of delivery or conditions of the shipment upon delivery, for example. At that time, the tracking module 30 has verification that the shipment has been completed and the information regarding the transaction is appropriately updated.

At this stage of the transaction, the transaction identifier preferably is directly linked with or contains information regarding a customer identification number, the purchase order number, a shipment release number, a packing slip number or an invoice number. By having all of this information contained within the transaction identifier or directly linked to it, the previously required steps of completing various invoices and receipt documents is eliminated.

Upon delivery, when the shipper scans in the bar code 40, for example, that information preferably is wirelessly communicated to the tracking module 30 and provided to at least three separate data sources. The supplier module 24 preferably receives a confirmation of the completed shipment. The customer module 28 also receives an indication that delivery has been made. Further, the carrier's data base is updated showing that they have completed their task of shipping the ordered goods.

The tracking module 30 preferably maintains the information regarding the transaction and automatically updates it upon receiving a communication from one or more of the other modules that are linked into the system 20. The tracking module may include a data base into which the information is stored. Alternatively, the customer and/or supplier module has a data base that is accessed by the tracking module.

The various types of communication utilized with a system according to this invention may be over an internet computer network or by wireless communication, which may be satellite-based or cell tower-based, for example. EDI 856 or 810 transmissions are example communication techniques that are effective for use in a system designed according to this invention.

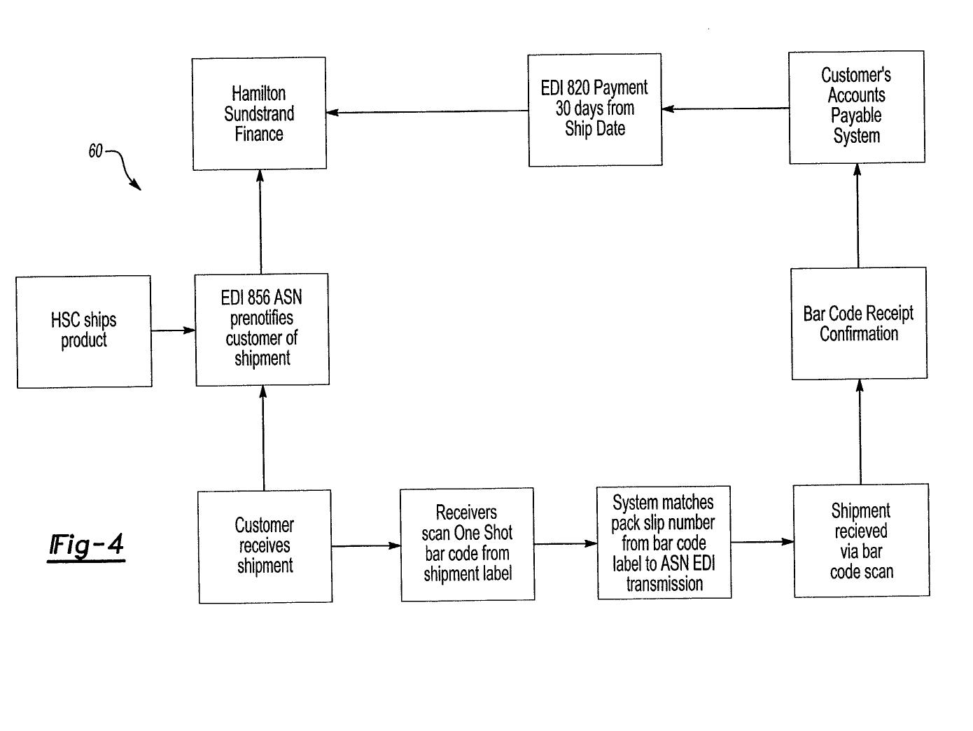

A system designed according to this invention preferably facilitates automatically carrying out certain phases of a transaction that previously required intervention by an individual. Another flow diagram 60 is shown in FIG. 4, which highlights payment features of a system designed according to this invention. In this example, once the supplier provides the order to the shipper, the system automatically sends a message to the customer module 28 notifying the customer module of the beginning of shipment. In instances where the agreement between the supplier and customer requires cash before delivery, the customer module 28 preferably responds to such a message by instigating an appropriate payment procedure. In this way, this invention enhances the supplier receiving payment more quickly than when a variety of individuals must be involved to track the appropriate information and complete necessary paperwork that was otherwise required.

At the same time that a message is provided to the customer module 28 regarding the beginning of shipment, the supplier module 24 preferably receives the same information. The supplier module 24 in one example is programmed to calculate a payment due date based upon the receipt of the message regarding the beginning of shipment. Another example utilizes the time the shipper scans in the bar code 40 upon arrival at the specified delivery location as the trigger to calculate payment schedule deadlines. In this manner, a system designed according to this invention facilitates a supplier more accurately tracking accounts payable and estimated or actual due dates.

In the example of FIG. 4, the agreement between the supplier and customer is one of cash on delivery. As the customer receives the shipment, the carrier preferably indicates that by scanning in, for example, the transaction identifier. In some instances, the customer will verify receipt by scanning in the transaction identifier on its own. Upon doing so, the customer module 28 preferably matches the packing slip number associated with the transaction identifier to the message received when shipment began to verify the completion of the shipping portion of the transaction. Once this information is confirmed, the customer module 28 preferably instigates a payment to the supplier by notifying an appropriate portion of the customer's accounts payable system, through electronic messaging or by automatically carrying out a payment authorization process. In the illustrated example, payment is electronically effected as the customer module 28 communicates with the supplier module 24 directly to indicate a transfer of funds from the appropriate customer account into the appropriate supplier account. Electronic fund transfers can be carried out in a conventional fashion.

Although the system accommodates a customer independently verifying receipt information, the supplier already has confirmed receipt because of the information scanned in by the carrier. This facilitates better accounting practices on the part of the supplier as delays that may be caused by the customer's own confirmation of the receipt do not affect the supplier's ability to track shipment.

A system designed according to this invention eliminates the multiple steps of reconciling information from various papers (such as packing slips, invoices and purchase orders) and the associated various identifying numbers that are part of a transaction. The single transaction identifier provides a way of linking or associating all information regarding the transaction so that it is readily accessed (to obtain information) and updated (to provide information) throughout the various phases of the transaction.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of electronically handling transactions, comprising the steps of:
establishing a transaction identifier that is used during all stages of an order-to-cash trading cycle;
electronically storing the transaction identifier such that the identifier is remotely accessible by a plurality of users;
linking supplier information with the transaction identifier;
linking purchaser information with the transaction identifier;
updating status information indicating the status of the transaction during a corresponding phase of the transaction; and
linking the status information to the transaction identifier.

2. The method of claim 1, including automatically providing at least selected portions of the information linked to the transaction identifier to a user.

3. The method of claim 1, including providing at least selected portions of the information linked to the transaction identifier to a user responsive to the user accessing the transaction identifier.

4. The method of claim 1, including automatically facilitating payment from a customer to a supplier responsive to determining that a selected portion of the transaction is complete.

5. The method of claim 4, including automatically determining payment schedule terms based upon selected criteria using the determined completion of the selected portion of the transaction.

6. The method of claim 1, including automatically updating the status information responsive to remotely received information regarding stages of the transaction.

7. A system for electronically processing transactions, comprising:
a transaction identifier that identifies a transaction; and
a tracking module that includes status information regarding the transaction and updates the status information during stages of the transaction, the tracking module providing access to the status information to a plurality of users such that a user of the system can automatically access the status information by using the transaction identifier.

8. The system of claim 7, wherein the transaction identifier comprises a single bar code representing a number.

9. The system of claim 8, wherein the transaction identifier includes information identifying a customer, a purchase order number, shipment release number and packing slip number.

10. The system of claim 7, including a customer module that includes information regarding at least one customer, the customer module facilitating the tracking module obtaining information regarding the customer and the status of the transaction where the status relates to the customer, the customer module linking the customer information with the transaction identifier.

11. The system of claim 10, including a supplier module that includes information regarding at least one supplier, the supplier module facilitating the tracking module obtaining information regarding the supplier and the status of the transaction where the status relates to the supplier, the supplier module linking the supplier information with the transaction identifier.

12. The system of claim 11, wherein the tracking, customer and supplier modules all each communicate with the other modules.

13. The system of claim 11, wherein the tracking, customer and supplier modules are each located remotely from the other modules.

14. The system of claim 7, wherein the tracking module communicates with a plurality of remotely located input devices and where the input devices provide status information regarding the transaction.

15. The system of claim 14, wherein at least one of the input devices is a shipper input device that a shipper uses to enter status information regarding the shipment and delivery portions of the transaction.

16. The system of claim 7, including a billing module that communicates with the tracking module and wherein the billing module automatically facilitates fund transfers between a customer account and a supplier account responsive to receiving shipment confirmation information from the tracking module.

17. The system of claim 7, wherein the tracking module comprises software.

18. A computer readable medium containing a plurality of computer executable instructions for electronically processing transactions, comprising:
a first instruction module establishing a transaction identifier that is used during all stages of a transaction;
a second instruction module electronically storing the transaction identifier such that the identifier is remotely accessible by a plurality of users;
a third instruction module linking supplier information with the transaction identifier;
a fourth instruction module linking purchaser information with the transaction identifier;
a fifth instruction module updating status information indicating the status of the transaction during a corresponding phase of the transaction;
a sixth instruction module linking the status information to the transaction identifier; and
a seventh instruction module automatically providing at least selected portions of the information linked to the transaction identifier responsive to a user accessing the transaction identifier.
